(19) United States
(12) Patent Application Publication
(10) Pub. No.: US 2019/0178288 A1
(43) Pub. Date: Jun. 13, 2019

(54) ROLLING BEARING UNIT

(71) Applicant: NTN CORPORATION, Osaka (JP)

(72) Inventors: Naota YAMAMOTO, Mie (JP); Shota TOHO, Mie (JP); Hiroshi UCHIMURA, Mie (JP)

(73) Assignee: NTN CORPORATION, Osaka (JP)

(21) Appl. No.: 16/308,124

(22) PCT Filed: Jun. 8, 2017
(86) PCT No.: PCT/JP2017/021330

§ 371 Date: Dec. 7, 2018

(30) Foreign Application Priority Data
Jun. 8, 2016 (JP) 2016-114331
Mar. 17, 2017 (JP) 2017-052742

(51) Int. Cl. F16C 19/38; F16C 33/66; F16C 33/80

(52) U.S. Cl. CPC F16C 19/38; F16C 33/80; F16C 33/6659

(57) ABSTRACT

A rolling bearing unit including a seal member includes a support frame having window holes, and a filter, the filter being fixedly joined to the support frame, or the support frame and the filter are formed by integral molding such that the window holes of the support frame are closed by the filter. The support frame has an inner diameter determined such that a passage through which lubricating oil can pass is defined between the support frame and the radially outer surface of the inner race. The filter includes a protruding portion protruding radially inwardly beyond the radially inner surface of the support frame such that the radially inner edge of the protruding portion is in contact with the inner race, or such that the protruding portion surrounds the radially outer surface of the inner race through a gap defined therebetween and smaller than the mesh size of the filter.

### TECHNICAL FIELD

The present invention relates to a rolling bearing including, inside thereof, a circulation path for oil so that the rolling bearing is lubricated by oil passing through the circulation path, and particularly a rolling bearing unit capable of preventing foreign objects generated in the bearing due to breakage of e.g., rolling surfaces, i.e., peeled-off metal pieces, from flowing out of the bearing.

### BACKGROUND ART

Rolling bearings are used for moving parts of transportation machinery industrial machines, and other machines and apparatus. Some of such machinery and apparatus include, besides the rolling bearings, which need oil lubrication, operating mechanism portions which also need lubrication, and which are lubricated by the same oil as used to lubricate the rolling bearings. Such operating mechanism portions include meshing portions of gears, and slide contact portions of sliding parts.

Some of such machinery include, inside thereof, rolling bearings and operating mechanisms. For example, an oil pump includes rolling bearings and an operating mechanism therein, and is configured to feed lubricating oil in the oil pump to a separate, external operating mechanism.

In a lubrication system including such an oil pump, the external operating mechanism is disposed at an intermediate portion of the oil circulation path such that lubricating oil returned from the external operating mechanism through the circulation path is passed through the interior of the rolling bearings in the pump, and fed again to the external operating mechanism.

In such a lubrication system, foreign objects generated in the rolling bearings as well as in the internal and external operating mechanisms, such as peeled-off metal pieces and wear dust, mix into the circulating lubricating oil, and flow into operating mechanism portions in the rolling bearings themselves and the external operating mechanism. This results in reduced endurance of the machine due to wedging of foreign objects, and also could results in malfunction, failure or breakage of the machine.

Thus, the below-identified Patent Documents 1-3 propose to close one side opening of the bearing space defined between the inner and outer races of the bearing with a seal member (such as a seal ring) with a filter to prevent, with this seal member, entry of foreign objects, such as iron dust, that have mixed into the lubricating oil flowing through the oil circulation path, into the bearing.

The below-identified Patent Document 4 proposes a seal member (seal ring) closing an end of the rolling bearing space (space between the inner and outer races), and including a filter for catching foreign objects.

### PRIOR ART DOCUMENTS

### Patent Documents

Patent Document 1: JP2628526B
Patent Document 2: JP2002-250354A
Patent Document 3: JP2011-256895A
Patent Document 4: JP5600555B

### SUMMARY OF THE INVENTION

### Object of the Invention

It is not preferable that foreign objects generated in the rolling bearing enter an operating mechanism disposed at an intermediate portion of the oil circulation path.

Among such foreign objects, large peeled-off pieces generated in a rolling bearing unit for an oil pump tend to cause especially significant damage to the operating mechanism portions of the oil pump itself as well as parts of external operating mechanisms, which could result in malfunction, failure or breakage of these machines.

Patent Documents 1-4 offers a partial solution to this problem because the seal member with the filter is disposed at the outlet of a portion of the lubricating oil circulation path in the bearing (side opening of the bearing space through which lubricating oil leaves the bearing), so that the filter of the seal member can filter out foreign objects generated in the bearing.

However, in Patent Documents 1-4, since the seal member includes a support frame formed with window holes used as lubricating oil passages, and the window holes are closed with the filter, the area of the filter where foreign objects are caught is small, so that the filter easily becomes clogged.

FIG. 2 of Patent Document 2 shows a structure in which substantially the entire area of a side opening between the inner and outer races is covered with an outer filter and an inner filter. With this structure, however, it is difficult to stably hold the filters in position because the filters receive flow pressure of the lubricating oil.

It would be possible to reduce clogging of the filter(s) by providing, between the seal member and one of the inner and outer rings of the bearing, a gap through which lubricating oil can leave the bearing without passing through the filter(s).

However, irrespective of whether such a gap is provided between the bearing outer race and the (annular) support frame of the seal member or between the bearing outer race and the annular support frame, such a gap would inevitably expand to some extent due e.g., to a manufacturing error of the seal member and/or a difference in thermal expansion between the seal member and the bearing.

This could result in foreign objects leaking out through such a gap, i.e., the gap between seal member and one of the inner and outer bearing races.

An object of the present invention is to keep relatively large objects, such as peeled-off pieces, that have been generated in the rolling bearing, in the bearing space between the inner and outer races, and thus to prevent them from flowing out of the bearing.

### Means for Achieving the Object

In order to achieve this object, according to the present invention, a conventional rolling bearing unit, i.e., a rolling bearing unit comprising an inner race supporting a rotary shaft; an outer race fixed to a housing, the inner race and the outer race defining a bearing space therebetween, the bearing space having an opening at one axial end thereof; rolling elements disposed in the bearing space; and a seal member attached to one axial end of the outer race at the one axial end of the bearing space so as to cover the opening of the bearing space, wherein the bearing space defines a circulation path for lubricating oil, the circulation path having an outlet at a position where there is the seal member, is configured as follows:

That is, the seal member includes a circular annular support frame having a plurality of window holes, and a filter having a predetermined mesh size, the filter being fixedly joined to the support frame, or the support frame and the filter are formed by integral molding such that the window holes are closed by the filter, wherein the support frame has an inner diameter determined such that a passage through which lubricating oil can pass is defined between the support frame and a radially outer surface of the inner race, and wherein the filter includes a protruding portion protruding radially inwardly beyond a radially inner surface of the support frame such that a radially inner edge of the protruding portion is in contact with the inner race, or such that the protruding portion surrounds the radially outer surface of the inner race through a gap defined therebetween and smaller than the mesh size of the filter.

The mesh size of the filter is preferably 0.2 mm or more and 0.5 mm or less, and the filter is preferably made of a resin such as a polyamide resin.

Preferably, the rolling bearing unit according to the present invention further comprises an additional foreign object catching arrangement other than the filter.

The additional foreign object catching arrangement may comprise a permanent magnet attached to the seal member at the outlet of the bearing space as the circulation path for lubricating oil, or may comprise a labyrinth disposed at the outlet of the circulation path, and having a bent portion.

If the permanent magnet is used, the permanent magnet may be fixedly embedded in the support frame, and the support frame may have dust-collecting recesses surrounding the permanent magnet, and configured to receive foreign objects therein.

Each dust-collecting recess may be shaped so as to gradually narrow from its opening at the surface of the support frame toward its bottom. If the permanent magnet is cylindrical, each dust-collecting recess may have an inner surface including a circular arc portion extending along the cylindrical outer surface of the permanent magnet.

Further preferably, the support frame of the seal member has foreign object guiding grooves each extending from the radially inner portion to an area inward of the window holes and configured to receive foreign objects generated in the bearing, or the rolling bearing unit may further comprise dust-collecting pockets disposed inward of the respective window holes, and configured to receive foreign objects that have moved through the respective foreign object guiding grooves.

The labyrinth disposed at the outlet of the circulation path for lubricating oil preferably narrows gradually from its inlet toward its outlet.

If the labyrinth narrows gradually from its inlet toward its outlet, and the permanent magnet is used, the permanent magnet is disposed at a position where its magnetic field reaches large portions of the labyrinth including its inlet.

### Advantages of the Invention

According to the present invention, by using the seal member having the above-described structure to close the opening of the bearing space between the inner and outer races at one end thereof, it is possible to define, between the inner race and the radially inner surface of the support frame of the seal member, a passage through which lubricating oil can smoothly flow out of the bearing unit.

Since this passage is closed by the protruding portion of the filter which protrudes radially inwardly beyond the radially inner surface of the support frame of the seal member such that lubricating oil can pass through this passage, compared with filters of conventional seal members, this filter has a large area where foreign objects are caught, so that this filter is less likely to become clogged with foreign objects.

Since the outlet of the circulation path for lubricating oil is closed by the seal member with no gap defined that is larger than the mesh size of the filter, it is possible to reliably prevent foreign objects generated in the bearing, such as peeled-off pieces, from flowing out of the bearing unit through a gap between the seal member and the inner race.

Since the support frame of the seal member is capable of retaining shape, the seal member can be stably supported by the bearing outer race or by a housing supporting the outer race.

By using the additional foreign object catching arrangement other than the filter, foreign objects generated in the bearing are partially caught by the additional foreign object catching arrangement, so that the filter is further less likely to be clogged with foreign objects.

By using the additional foreign object catching arrangement comprising a permanent magnet, peeled-off pieces of magnetic material are attracted toward and gathered around the permanent magnet so as not to be escapable therefrom.

By using the additional foreign object catching arrangement comprising the labyrinth, foreign objects such as peeled-off pieces get caught or stuck in the labyrinth, so that they are less likely to flow out of the bearing space. By using both the labyrinth and the permanent magnet, it is possible to more reliably prevent the escape of foreign objects caught.

The filter is preferably made of a resin because a resin filter never damages the bearing inner race when it touches the inner race, so that it is possible to completely eliminate a gap between the seal member and the inner race, which in turn makes it possible to reduce the distance between the outer periphery of the inner race and the inner edge of the filter (i.e., the dimension of the gap therebetween), to a value smaller than the mesh size of the filter.

The reason why the mesh size of the filter is preferably 0.2 mm or more and 0.5 mm or less is described later.

The following reasons are also described later: the reason why the support frame of the seal member preferably has the guiding grooves and/or the dust-collecting pockets, the reason why the labyrinth preferably narrows gradually from its inlet toward its outlet; and the reason why, if the labyrinth narrowing gradually from its inlet toward its outlet is used in combination with the permanent magnet, the permanent magnet is preferably disposed at a position where its magnetic field reaches large portions of the labyrinth including its inlet.

### BRIEF DESCRIPTION OF THE DRAWINGS

FIG. 1 is a schematic sectional view of an oil pump using a bearing unit according to the present invention.

FIG. 2 is a sectional view taken along line X-X of FIG. 1, and showing a portion of the oil pump of FIG. 1.

FIG. 3 is a front view of an exemplary seal member of the rolling bearing unit according to the present invention.

FIG. 4 is a sectional view of a portion of the rolling bearing unit with the seal member of FIG. 2 attached thereto.

FIG. 5 is a front view of a different seal member to be attached to rolling bearing unit according to the present invention.

FIG. 6 is a sectional view of a portion of the rolling bearing unit with the seal member of FIG. 6 attached thereto.

FIG. 7 is a sectional view of a portion of the rolling bearing unit with a seal member attached thereto, the seal member being different from the seal member of FIG. 6 in that permanent magnets are disposed at different locations.

FIG. 8 is a front view of still another seal member to be attached to the rolling bearing unit according to the present invention.

FIG. 9 is a front view of yet another seal member to be attached to the rolling bearing unit according to the present invention.

FIG. 10 is a sectional view of a portion of the rolling bearing unit with the seal member of FIG. 9 attached thereto.

FIG. 11 is a front view of a still different seal member to be attached to the rolling bearing unit according to the present invention.

FIG. 12(a) is an enlarged front view of a portion of FIG. 11; and FIG. 12(b) is a sectional view of FIG. 12(a).

FIG. 13 is a sectional view of a modification of FIG. 11.

FIG. 14 is a sectional view of another rolling bearing unit according to the present invention, which includes a labyrinth.

FIG. 15 is an enlarged sectional view taken along line Y-Y of FIG. 14.

FIG. 16 is a sectional view of a portion of a rolling bearing unit to which the seal member of FIG. 2 is attached such that the seal member defines a labyrinth for preventing foreign objects from moving in a straight line.

FIG. 17 is a sectional view of a portion of a rolling bearing unit to which the seal member of FIG. 7 is attached such that the seal member defines a labyrinth for preventing foreign objects from moving in a straight line.

FIG. 18 is an enlarged sectional view of a portion of an inner ring of a support frame of a seal member, the inner ring being formed with grooves on its radially outer surface, instead of forming grooves on the radially inner surface of an outer annular portion of a non-linear-path-defining ring as shown in FIG. 14.

FIG. 19 is a sectional view of a portion of another rolling bearing unit according to the present invention to which the seal member of FIG. 7 is attached such that the seal member defines a labyrinth for preventing foreign objects from moving in a straight line.

### EMBODIMENTS

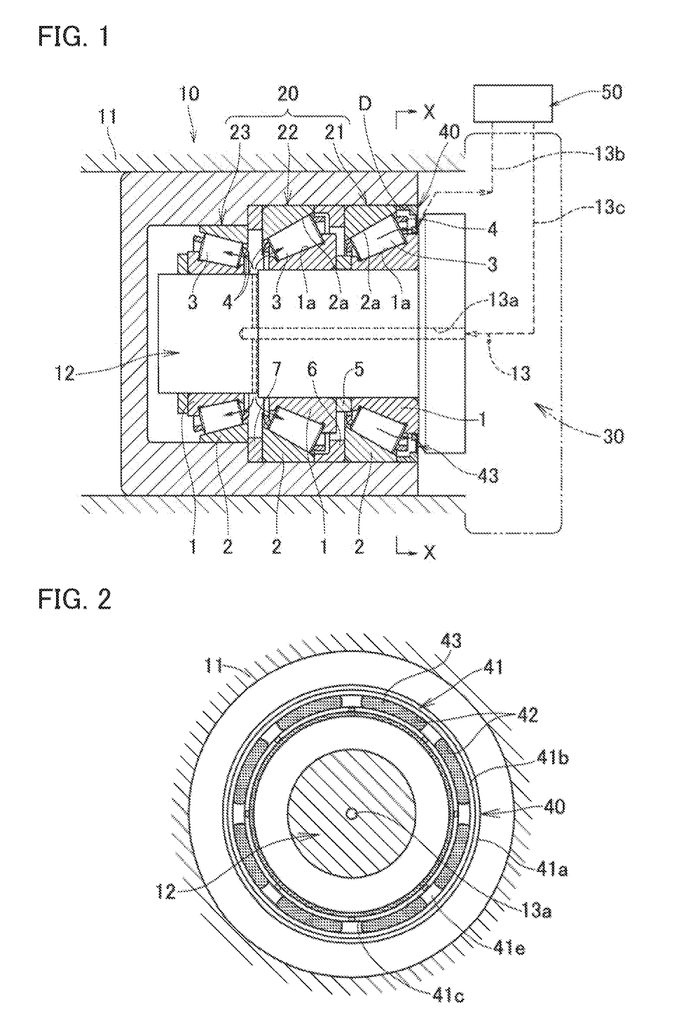

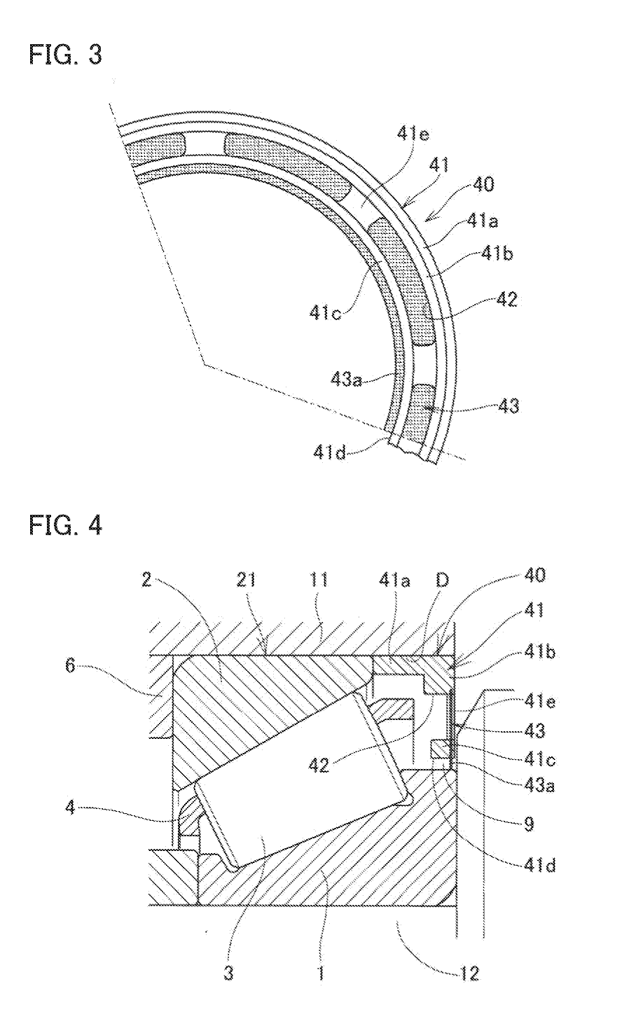

Now referring to FIGS. 1-19, a bearing unit embodying the present invention, as used in an oil pump, is described.

The oil pump is designated by numeral 10 in FIG. 1, and includes, inside thereof, the bearing unit 20, and an operating mechanism 30 including a pump rotor (not shown) that sucks, compresses, and discharge oil.

The bearing unit 20 includes three rolling bearings 21, 22 and 23 that are juxtaposed to each other in a housing 11, and lubricated by oil.

The rolling bearings 21, 22 and 23 support a rotary shaft 12 of the oil pump, and the rotary shaft 12 drive the pump rotor of the operating mechanism 30 so that the pump rotor sucks, compresses, and discharges oil.

The rolling bearing 21, 22 and 23 are known bearings each including an inner (bearing) race 1 having a raceway 1a, an outer (bearing) race 2 having a raceway 2a, and rolling elements (tapered rollers in the example shown) 3 disposed between the raceways 1a and 2a of the inner and outer races. The rolling elements 3 are retained by a retainer 4 so as to be circumferentially equidistantly spaced apart from each other.

The outer races 2 of the respective rolling bearings 21, 22 and 23 are press-fitted in the radially inner surface of the housing 11 so as to be non-rotatable.

The inner races 1 of the respective rolling bearings 21, 22 and 23 are fixed to the outer periphery of the rotary shaft 12 so as to be non-rotatable relative to the rotary shaft 12.

The rolling elements 3 of the rolling bearings 21, 22 and 23 may be spherical or cylindrical rolling elements. The number of rolling bearings of the bearing unit 20 is not limited. Spacers 5, 6 and 7 shown in FIG. 1 maintain the positional relationships between the rolling bearings 21, 22 and 23.

Lubricating oil compressed in and discharged from the pump rotor passes through a circulation path 13 in the oil pump 10.

A hole 13a in the rotary shaft 12 along its center axis forms part of the circulation path 13. Lubricating oil that has passed through the hole 13a passes through the bearing space between the inner and outer races 1 and 2 of the rolling bearing 22, through the bearing space between the inner and outer races 1 and 2 of the rolling bearing 21, and through a discharge passage 13b in the housing 11, and flows into an operating mechanism 50 disposed outside the pump.

From the operating mechanism 50, lubricating oil flows through a return passage 13c in the housing 11 into the operating mechanism 30 inside the oil pump, where the lubricating oil is sucked by the pump rotor and discharged back into the circulation path 13.

In the case of the oil pump 10 shown, if peeling occurs on the raceways 1a or 2a of the rolling bearing 21 or 22, or on the rolling surface of any rolling element 3, peeled-off pieces could mix into the oil flowing through the circulation path 13, and flow toward the operating mechanism 50.

The bearing unit 20 includes a seal member 40 attached to the rolling bearing 21, which is located at the downstream end, in the oil flow direction, of the portion of the circulation path 13 in the bearing unit 20, at one of the two open ends of the rolling bearing 21, i.e., at the side opening D of the bearing space of the rolling bearing 21 through which lubricating oil leaves the rolling bearing 21.

Referring to FIGS. 2-4, the seal member 40 includes a circular annular support frame 41 having window holes 42, and a filter 43 having a predetermined mesh size and fixedly joined to the support frame 41 to close the window holes 42. The filter 43 and support frame 41 may be formed by integral molding, too.

In the example shown, the support frame 41 includes a cylindrical portion 41a; an end wall 41b integrally connected to one end of the inner periphery of the cylindrical portion 41a and having the window holes 42; and an inner ring 41c integrally connected to the inner edge of the end wall 41b to extend toward the other end of the cylindrical portion 41a. The support frame 41 is fixed in position by e.g., press-fitting the cylindrical portion 41a into a hole of the housing 11, or by coupling the cylindrical portion 41a to the outer race 2 of the rolling bearing 21 with a coupling member (now shown).

The window holes 42 of the support frame 41 are circumferentially spaced apart from each other, and closed by the filter 43, through which oil can pass.

In the example shown, the support frame 41 of the seal member 40 is made of a fiber-reinforced polyamide resin, while the filter 43 is a polyamide resin mesh filter. While the materials of the support frame 41 and the filter 43 are not particularly limited, for lower cost and lightness in weight, resins that are resistant to oil and ensure necessary strength are preferable.

Resins that meet these requirements include super-engineering plastics such as polysulfone (PSF), polyethersulfone (PES), polyphenylene sulfide (PPS), polyarylate (PAR), polyamide imide (PAI), polyether imide (PEI), polyetheretherketone (PEEK), liquid crystal polymer (LCP), thermoplastic polyimide (TPI), polybenzimidazole (PBI), polymethyl-pentene (TPX), poly 1,4-cyclohexane dimethylene terephthalate (PCT), polyamide 46 (PA46), polyamide 6T (PA6T), polyamide 9T (PA9T), polyamide 11, 12 (PA11, 12), polytetrafluoroethylene (PTFE), and tetrafluoroethylene-perfluoroalkyl vinyl ether copolymer (PFA), tetrafluoroethylene-ethylene copolymer (ETFE).

Among them, self-lubricating synthetic resins, such as polyetheretherketone (PEEK) and polyphenylene sulfide (PPS), are high in oil resistance and can be used in hostile environments such as where there is a refrigerant (by adding, if necessary, a filler such as carbon fiber (CF) or glass fiber (GF)).

Among such self-lubricating synthetic resins, polyamide resins (PA: PA66 and PA46) are used widely in industrial machines (by adding, if necessary, a filler such as carbon fiber (CF) or glass fiber (GF)), because they are easily injection moldable and are inexpensive.

The inner ring 41c of the support frame 41 of the seal member 40 has an inner diameter determined such that a passage 9 (see FIG. 4) through which oil can flow is defined between the inner ring 41b and the inner race 1 of the rolling bearing 21.

The filter 43 has a protruding portion 43a protruding radially inwardly beyond the radially inner surface 41d of the inner ring 41c. In the example shown, the radially inner edge of the protruding portion 43a is in contact with the inner race 1 of the rolling bearing 21, but the protruding portion 43a may be sized such that it does not contact the inner race 1 of the rolling bearing 21, and instead, there is a gap therebetween that is smaller than the mesh size of the filter 43. However, the protruding portion 43a preferably has a sufficiently large radial dimension such that, even when the filter 43 is thermally expanded, no gap will form between the protruding portion 43a and the inner race 1, or even if such a gap forms, it will not increase excessively.

The protruding portion 43a of the filter 43 may be a separate part from the portion of the filter 43 closing the window holes 42. However, the seal member 40 can be more easily manufactured by attaching, as the filter 43, a one-piece annular filter material having an outer diameter larger than the diameter of the circle passing through the radially outer peripheries of the window holes 42, to the support frame 41 by molding such that the radially inner portion of the one-piece annular filter material protrudes radially inwardly beyond the radially inner surface of the support frame 41 to provide the protruding portion 43a. Such a protruding portion 43a can be more stably held in position too.

The mesh size of the filter 43 is preferably 0.2 mm or more and 0.5 mm or less. If the mesh size is less than 0.2 mm, the filter 43 is more likely to become clogged.

If the mesh size of the filter 43 is larger than 0.5 mm, foreign objects produced in the bearing unit and larger than 0.5 mm can flow out of the bearing unit.

It has been confirmed by experiments that foreign objects larger than 0.5 mm leave impressions larger than 1 mm on rolling surfaces and slide contact surfaces if such foreign objects become wedged into these surfaces, and such large impressions quickly shorten the lives of the affected devices.

By choosing a mesh size of 0.5 mm or less, foreign objects larger than 0.5 mm can be filtered out, so that it is possible to prevent such large foreign objects from shortening the lives of devices.

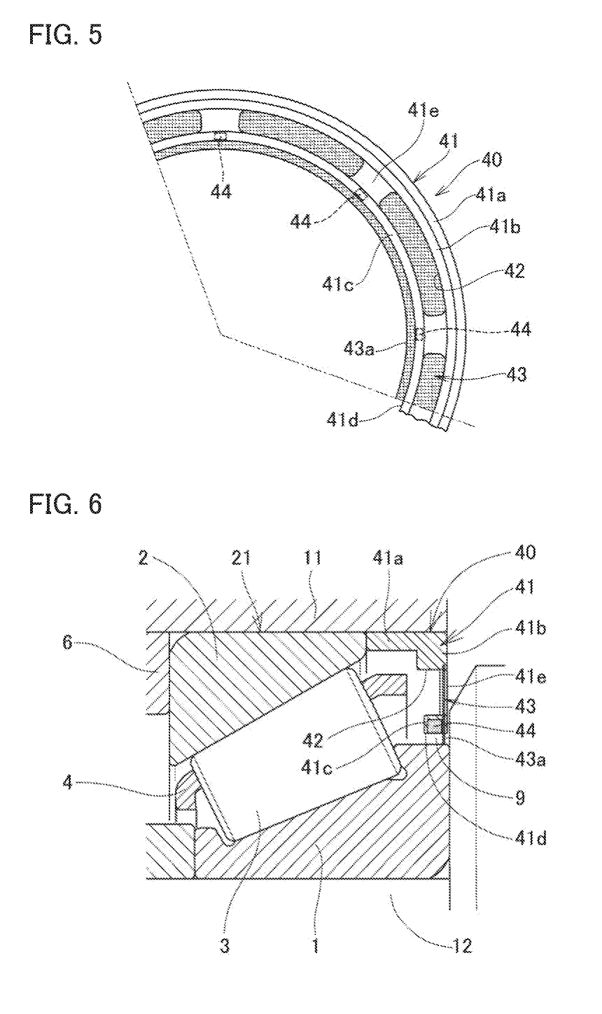

In order to effectively prevent foreign objects generated in the bearing unit, such as peeled-off pieces, from flowing out of the bearing unit, it is also important to prevent the foreign objects caught by the filter from leaving the filter. For that purpose, as shown in FIGS. 5-9, permanent magnets 44 may be attached to the seal member 40 as an additional foreign object catching arrangement other than the filter 43.

In each of the embodiments of FIGS. 5 and 6 and FIGS. 8 and 9, the permanent magnets 44 are embedded in the radially inner surface of the inner ring 41c of the support frame 41 of the seal member 40 at locations upstream of the protruding portion 43a of the filter 43 (i.e., within the bearing space) so as to be opposed to the passage 9 defined between the support frame 41 and the inner race 1 of the rolling bearing 21.

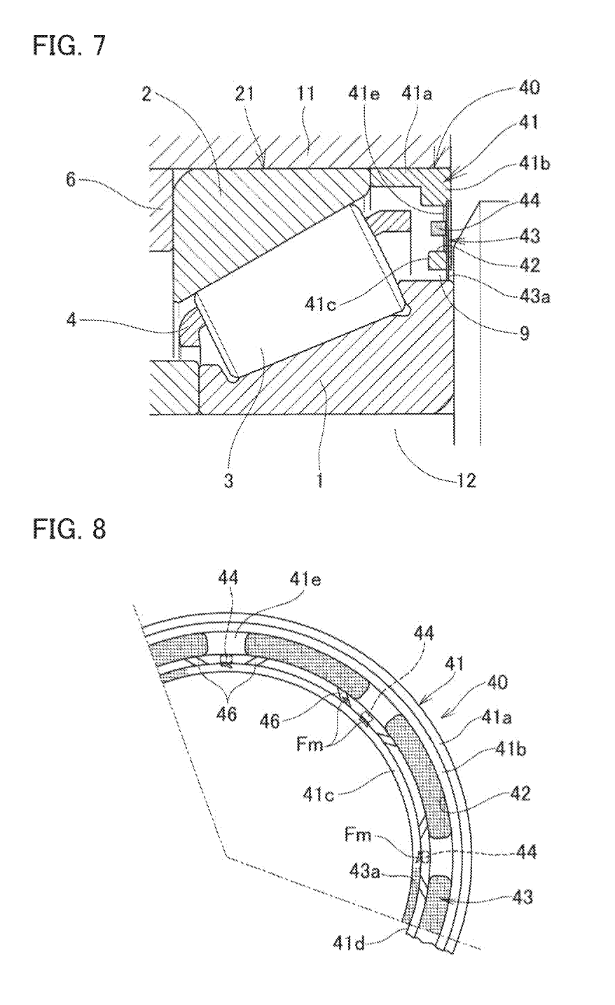

In the embodiment of FIG. 7, the permanent magnets 44 are attached to the inner surfaces of ribs 41e defining the window holes 42 in the end wall 41b of the support frame 41 of the seal member 40.

The permanent magnets 44 attract foreign objects of magnetic material, thereby stopping the flow of foreign objects in the oil flow in the circulation path 13. This makes it more difficult for foreign objects to flow out of the bearing unit. Also, by attracting foreign objects, the permanent magnets 44 more effectively reduce the possibility of clogging of the filter 43.

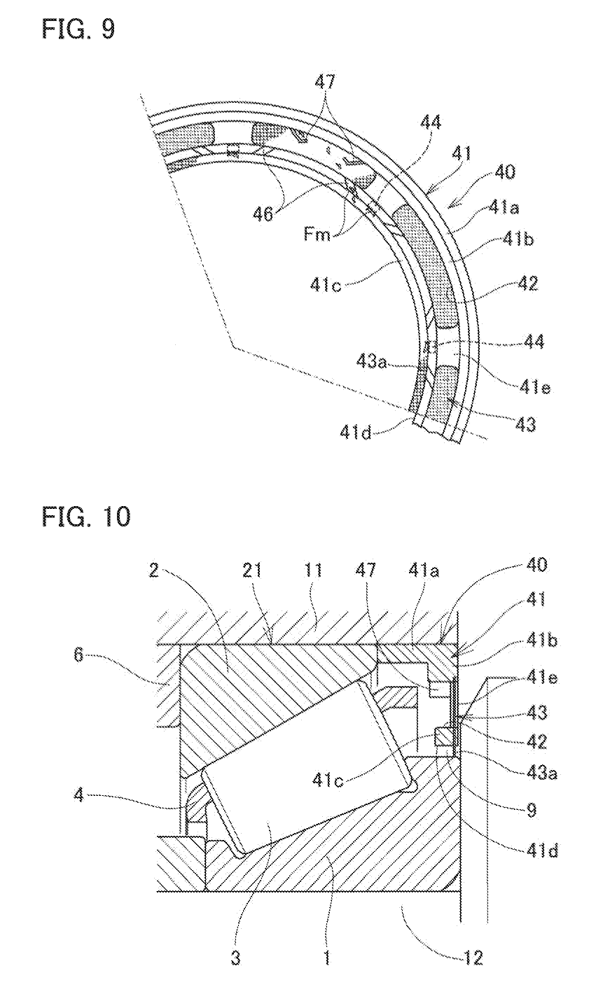

In order to more effectively prevent foreign objects from flowing out of the bearing unit, the seal member 40 may include foreign object guiding grooves 46 shown in FIGS. 8 and 9, and/or dust-collecting pockets 47 shown in FIGS. 9 and 10.

The foreign object guiding grooves 46 shown in FIGS. 8 and 9 are formed in the inner surface of the inner ring 41c of the support frame of the seal member to extend (preferably obliquely to the oil flow direction) from the passage 9 to respective ones of the window holes 42.

By the provision of the foreign object guiding grooves 46, foreign objects Fm that have flowed into the passage 9 without being attracted by the permanent magnets 44 due to the permanent magnets 44 being unable to attract all of foreign objects can be moved back into the window holes 42 together with the oil flow (in the direction of arrows in FIG. 8) by centrifugal force, so that foreign objects are less likely to flow back into the passage 9.

The dust-collecting pockets 47 shown in FIGS. 9 and 10 are disposed inward of the window holes 42, and collect foreign objects Fm that have flowed into the window holes 42. This more effectively reduces the possibility of foreign objects Fm flowing back into the passage 9 and out of the bearing unit through the radially inner edge of the filter 43.

By collecting foreign objects, the dust-collecting pockets 47 prevent scattering of foreign objects, thereby reducing the possibility of the surfaces of the portions of the filter 43 covering the window holes 42 becoming clogged with scattered foreign objects.

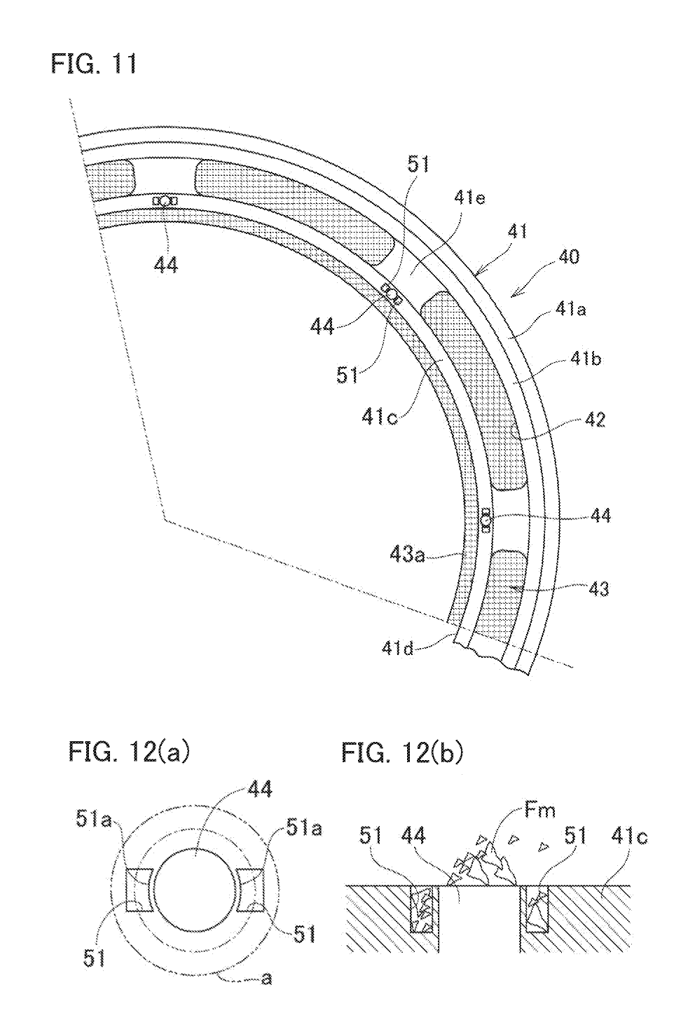

In the embodiment of FIG. 11, the permanent magnets 44 are fixedly embedded in the support frame 41 of the seal member 40, at locations close to the radially inner edge of the support frame 41. In the specific example shown, the permanent magnets 44 are fixed to the inner ring 41c of the support frame 41. While, in the example shown, the permanent magnets 44 are exposed to the axial end surface of the inner ring 41c, the permanent magnets 44 may be completely embedded in the inner ring 41c so as not to be exposed. Also, the permanent magnets 44 may be fixed to portions of the seal member 40 other than the inner ring 41c.

The support frame 41 includes, around, i.e., on both sides of, each permanent magnet 44, pocket-shaped dust-collecting recesses 51 for collecting foreign objects Fm. The permanent magnets 44 and the dust-collecting recesses 51 constitute an additional foreign object catching arrangement of the seal member 40 other than the filter.

By the provision of the pocket-shaped dust-collecting recesses 51 on both sides of the respective permanent magnets 44, foreign objects Fm magnetically attracted to the permanent magnets 44 are retained in the dust-collecting recesses 51 so as not to flow out of the bearing unit.

In this embodiment, the permanent magnets 44 are cylindrical member having cylindrical surfaces 44a on the outer peripheries thereof. The inner surface of each dust-collecting portion 51 has, as shown in. FIG. 12(a), a circular arc portion 51a extending along the cylindrical outer surface 44a of the corresponding permanent magnet 44. This causes substantially equal magnetic forces to be generated in the space of the dust-collecting recess 51 along the circular arc portion 51a, so that foreign objects Fm can be caught over the entire dust-collecting recess 51.

The seal member 40 is formed by injecting molten resin into a mold with the permanent magnets 44 disposed in the mold so that the permanent magnets 44 are integral with the seal member 40. It is usually difficult to prevent the permanent magnets 44 from being moved in the mold by the injected molten resin from the predetermined positions, by the time the molten resin hardens. However, since the mold used to form the seal member 40 of the embodiment of FIGS. 11, 12(a) and 12(b) includes protrusions for forming the dust-collecting recesses 51, such protrusions serve to keep the permanent magnets 44 at the predetermined positions. The effect of preventing movements of the permanent magnets 44 is further strengthened by the fact that the permanent magnets 44 are cylindrical, and the inner surface of each dust-collecting recess 51 has a circular arc portion 51a extending along the cylindrical outer surface 44a.

FIG. 12(b) shows how foreign objects Fm are magnetically attracted to one of the permanent magnets 44. If the flow of lubricating oil, shown by arrow in FIG. 12(b), is fast, without the dust-collecting recesses 51, the foreign objected Fm attracted to the permanent magnet 44 could flow out of the bearing unit. However, by the provision of the dust-collecting recesses 51 adjacent to the permanent magnets 44, even if foreign objects Fm separate from the permanent magnets 44, such foreign objects Fm enter the dust-collecting recesses 51. Once in the dust-collecting recesses 51, foreign objects are not affected by the flow of lubricating oil, so that they can be retained in the dust-collecting recesses 51. Thus, it is possible to prevent foreign objects Fm caught by the permanent magnets 44 from flowing out of the bearing unit. The dust-collecting recesses 51 are preferably positioned where foreign objects Fm can be magnetically attracted to the respective permanent magnets 44, but even if they are positioned outside the influence of any permanent magnet 44 (i.e., where foreign objects Fm cannot be magnetically attracted to any permanent magnet 44), foreign objects Fm can still be caught in such dust-collecting recesses 51.

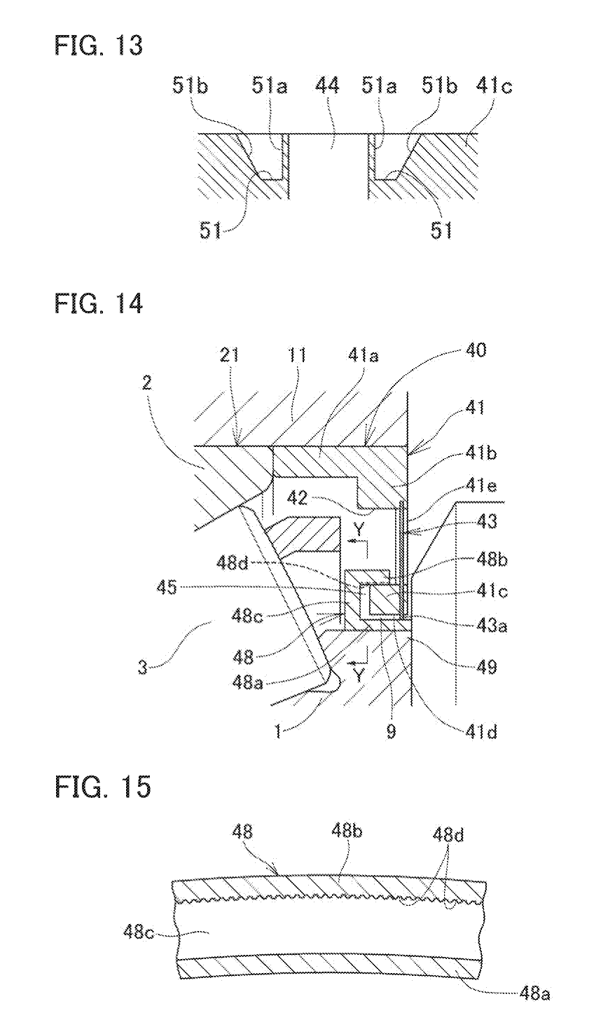

As an alternative, as shown in FIG. 13, each dust-collecting recess 51 may be shaped so as to gradually narrow from its opening at the surface of the support frame 41 toward its bottom. In the particular example shown in FIG. 13, the portion of the inner surface of each dust-collecting recess 51 opposite from the circular arc portion 51a comprises an inclined portion 51a inclined so as to gradually approaches the circular arc portion 51a from its opening toward its bottom.

By shaping each dust-collecting recess 51 such that its opening is wider than its bottom, a larger amount of foreign objects Fm can be caught in the dust-collecting recess 51. The larger the amount of foreign objects Fm caught in the dust-collecting recesses 51, the less likely foreign objects Fm are to close the openings of the dust-collecting recesses 51.

In order that each dust-collecting recess 51 narrows gradually from its opening toward its bottom, the portion of its inner surface remote from the permanent magnet 44 may comprise the inclined portion 51b as shown in FIG. 13, or the portion of its inner surface close to the permanent magnet 44 may be inclined. Also, a portion of its inner surface other than the above two portions may be inclined.

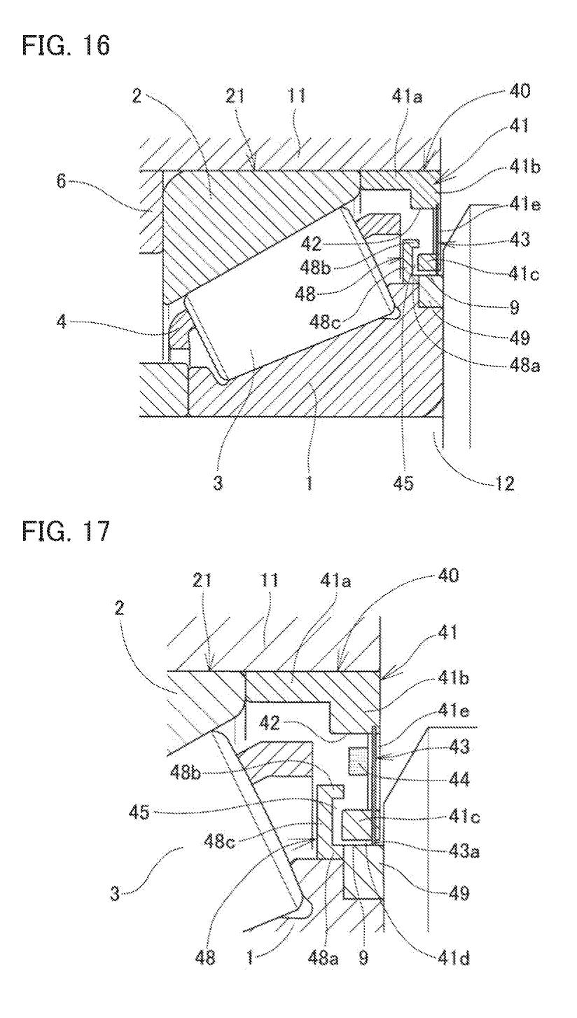

The seal member 40 of FIGS. 16 and 17 includes an additional foreign object catching arrangement other than the filter that comprises a portion of the circulation path 13.

In particular, such an additional foreign object catching arrangement other than the filter comprises a labyrinth 45 at the outlet of the portion of the circulation path 13 defined by the bearing space of the rolling bearing 21.

The labyrinth 45 is defined by a non-linear-path-defining ring 48 having a “ [symbol] ” -shaped cross-section, and an anti-separation ring 49 engaging the non-linear-path-defining ring 49.

The non-linear-path-defining ring 48 includes an inner annular portion 48a, an outer annular portion 48b, and an end wall 48c integrally connected to one end of each annular portion. The non-linear-path-defining ring 48 is disposed inwardly of the seal member 40 (i.e., within the bearing space) while being properly spaced from the seal member 40 to define the labyrinth 45 between the non-linear-path-defining ring 48 and the support frame 41 of the seal member 40.

The non-linear-path-defining ring 48 is fitted on the inner race 1 of the bearing with other ends of the inner and outer annular portions 48a and 48b directed outwardly, and the free end of the inner ring 41c of the seal member 40 is inserted between the inner and outer annular portions 48a and 48b of the non-linear-path-defining ring 48.

The labyrinth 45 therefore extends downward, inward, downward, and then outward, so that foreign objects Fm, such as peeled-off pieces, that have flowed into the labyrinth 45 get caught or stuck at bent corners of the labyrinth 45, and cannot easily flow out of the bearing space.

In this embodiment, a large number of passage grooves 48d are defined between the inner annular portion 48a of the non-linear-path-defining ring 48, which has the outer annular portion 48b, and the inner ring 41c of the support frame of the seal member so that even if, as shown in FIG. 14, the inner ring 41c is thermally expanded until the gap between the inner annular portion 48a and the inner ring 41c of the support frame of the seal member disappears, a flow path remains therebetween. Otherwise, the inner annular portion 48a may be fitted to the outer periphery of inner ring 41c such that they contact with each other from the beginning.

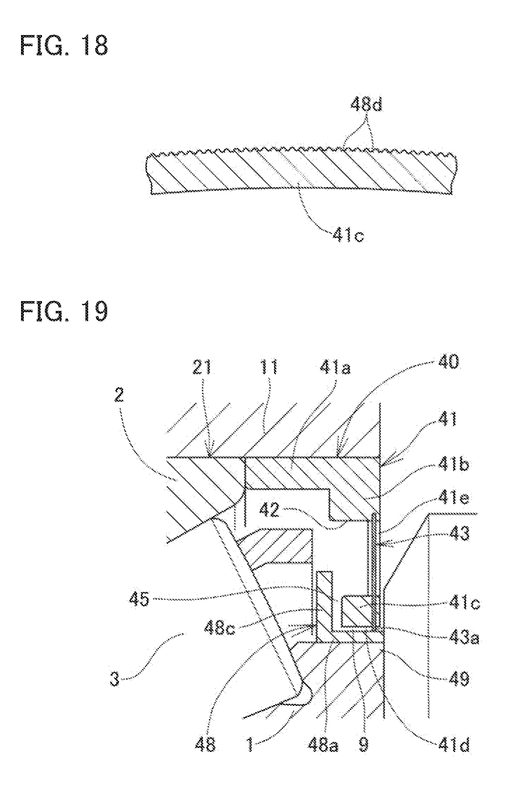

The passage grooves 48d may comprise, as shown in FIG. 15, axial grooves formed in the radially inner surface of the inner annular portion 48a, or, as shown in FIG. 18, axial grooves formed in the radially outer surface of the inner ring 41c of the support frame of the seal member.

While the shapes of the passage grooves 48d are not particularly limited, if they are sized to be equivalent to the mesh size of the filter 43, foreign objects can be filtered at the inlets of the passage grooves.

The non-linear-path-defining ring 48 may be a ring having an L-shaped cross-section formed by an inner annular portion 48a and an end wall 48c shown in FIG. 19.

The shape of the labyrinth 45 may be determined su h that its flow path size gradually decreases from its inlet toward its outlet so that foreign objects that have entered the labyrinth can hardly pass therethrough, and thus to further effectively catching foreign objects.

The seal member 40 may include both such a labyrinth 45, i.e., a labyrinth having a flow path size that gradually decreases from its inlet toward its outlet, and the above-described permanent magnets 44. In that case, as shown in FIG. 12, the permanent magnets 44 may be arranged near the inlet of the labyrinth 45, or at positions where their magnetic fields reach large portions of the labyrinth 45 so that foreign objects can be caught at a plurality of locations, and thus to more effectively prevent foreign objects from flowing out of the bearing unit.

The anti-separation ring 49 is attached to the outer periphery of the inner race 1 of the bearing by e.g., press-fitting, and prevents separation of the non-linear-path-defining ring 48 from the inner race 1.

### DESCRIPTION OF THE NUMERALS

1. Inner race
1a. Raceway
2. Outer race
2a. Raceway
3. Rolling element
4. Retainer
5, 6, 7. Spacer
8. Presser member
9. Passage
10. Oil pump
11. Housing
12. Rotary shaft
13. Circulation path for lubricating oil
13a. Hole
13b. Discharge passage
13c. Return passage
20. Bearing unit
21, 22, 23. Rolling bearing
30. Operating mechanism
40. Seal member
41. Support frame
41a. Cylindrical portion
41b. End wall
41c. Inner ring
41d. Radially inner surface
41e. Rib
42. Window hole
43. Filter
43a. Radially inwardly protruding portion
44. Permanent magnet
44a. Cylindrical outer surface
45. Labyrinth
46. Foreign object guiding groove
47. Dust-collecting pocket
48. Non-linear-path-defining ring
48a. Inner annular portion
48b. Outer annular portion
48c. End wall
48d. Passage groove
49. Anti-separation ring
50. Operating mechanism
51. Dust-collecting recess
51a. Circular arc portion
51b. Inclined portion
Fm. Foreign objects

1. A rolling bearing unit comprising:
an inner race supporting a rotary shaft;
an outer race fixed to a housing, the inner race and the outer race defining a bearing space therebetween, the bearing space having an opening at one axial end thereof;
rolling elements disposed in the bearing space; and
a seal member attached to one axial end of the outer race at the one axial end of the bearing space so as to cover the opening of the bearing space, wherein the bearing space defines a circulation path for lubricating oil, the circulation path having an outlet at a position where there is the seal member,
the seal member including, either:
(i) a circular annular support frame having a plurality of window holes, and a filter having a predetermined mesh size, the filter being fixedly joined to the support frame, or the support frame and the filter are formed by integral molding such that the window holes are closed by the filter, wherein the support frame has an inner diameter determined such that a passage through which lubricating oil can pass is defined between the support frame and a radially outer surface of the inner race, and wherein the filter includes a protruding portion protruding radially inwardly beyond a radially inner surface of the support frame such that a radially inner edge of the protruding portion is in contact with the inner race, or such that the protruding portion surrounds the radially outer surface of the inner race through a gap defined therebetween and smaller than the mesh size of the filter; or
(ii) a support frame having no window holes and having a large number of holes, each of a size equivalent to the mesh size of the filter, at locations where the window holes are to be provided, the seal member being free of the filter.

2. The rolling bearing unit of claim 1, wherein the support frame includes:
a cylindrical portion;
an end wall integrally connected to an inner periphery of the cylindrical portion at one end of the cylindrical portion, the end wall having the window holes; and
an inner ring integrally connected to an inner end of the end wall and extending toward another end of the cylindrical portion opposite from the one end of the cylindrical portion,
wherein the filter has an outer diameter larger than a diameter of a circle passing through outer peripheries of the window holes, the filter being attached to the support frame by molding, and wherein the protruding portion comprises a radially inner portion of the filter.

3. The rolling bearing unit of claim 1, further comprising an additional foreign object catching arrangement other than the filter, the additional foreign object catching arrangement comprising a permanent magnet attached to the seal member.

4. The rolling bearing unit of claim 3, wherein the permanent magnet is disposed in a vicinity of the outlet of the circulation path.

5. The rolling bearing unit of claim 3, wherein the permanent magnet is fixedly embedded in the support frame, and wherein the support frame has dust-collecting recesses surrounding the permanent magnet, and configured to receive foreign objects therein.

6. The rolling bearing unit of claim 5, wherein each of the dust-collecting recesses has an opening at a surface of the support frame, and a bottom, and is shaped so as to gradually narrow from the opening toward the bottom.

7. The rolling bearing unit of claim 5, wherein the permanent magnet is cylindrical in shape, and has a cylindrical outer surface on an outer periphery thereof, and each of the dust-collecting recesses has an inner surface including a circular arc portion extending along the cylindrical outer surface of the permanent magnet.

8. The rolling bearing unit of claim 1, further comprising an additional foreign object catching arrangement other than the filter, the additional foreign object catching arrangement comprising a labyrinth disposed at the outlet of the circulation path, and having a bent portion.

9. The rolling bearing unit of claim 8, further comprising a non-linear-path-defining ring having a “⊐”- or L-shaped cross-section, and fitted on the inner race, wherein the labyrinth is defined between the non-linear-path-defining ring and the support frame of the seal member.

10. The rolling bearing unit of claim 9, wherein the non-linear-path-defining ring has a “⊐”-shaped cross-section and includes an inner annular portion, an outer annular portion-, and an end wall integrally connected to one end of each of the inner annular portion and the outer annular portion, wherein the outer annular portion is fitted on an outer periphery of the inner ring with a slight gap therebetween or with no gap therebetween, and wherein one of a radially inner surface of the outer annular portion and a radially outer surface of the inner ring has passage grooves.

11. The rolling bearing unit of claim 1, wherein the support frame has, in an inner surface thereof, foreign object guiding grooves each extending from the passage to a respective one of the window holes.

12. The rolling bearing unit of claim 11, further comprising dust-collecting pockets disposed inward of the respective window holes, and configured to receive foreign objects that have moved through the respective foreign object guiding grooves to the respective window holes.

13. The rolling bearing unit of claim 1, wherein the mesh size of the filter is 0.2 mm or more and 0.5 mm or less.

14. The rolling bearing unit of claim 1, wherein the rolling elements comprise tapered rollers, and the rolling bearing unit comprises a tapered roller bearing unit.
